(19) United States
(12) Patent Application Publication
(10) Pub. No.: US 2025/0084696 A1
(43) Pub. Date: Mar. 13, 2025

(54) DRIVING DEVICE FOR ELECTRIC CURTAIN AND ELECTRIC CURTAIN

(71) Applicant: NINGBO SUNFREE MOTOR TECHNOLOGY COMPANY LIMITED, Ningbo City, Zhejiang Province (CN)

(72) Inventor: Yongqiang ZHOU, Ningbo City, Zhejiang Province (CN)

(21) Appl. No.: 18/552,888

(22) PCT Filed: Mar. 21, 2022
(86) PCT No.: PCT/CN2022/081908

§ 371 Date: Sep. 27, 2023

(30) Foreign Application Priority Data
Mar. 31, 2021 (CN) 202120662621.1

(51) Int. Cl. E06B 9/70

(52) U.S. Cl. CPC E06B 9/70

(57) ABSTRACT

The present disclosure discloses a driving device for an electric curtain and an electric curtain, comprising a main box and a secondary box connected to an end of the main box. A motor and a planetary gear set in transmission connection with the motor are disposed inside the main box. A horizontal gear set is disposed inside the secondary box. The planetary gear set is in transmission connection with the horizontal gear set, and a transmission shaft in transmission connection with the horizontal gear set is disposed outside the secondary box. The single-stage planetary gear set can greatly reduce the mounting accuracy, facilitating production and mounting and the flat structure enables it to be easily disposed at one or two sides of the electric curtain. Thus, entire mounting is easier, the accuracy requirement is lower and operation is more stable and reliable.

### TECHNICAL FIELD

The present invention relates to the technical field of electric curtains, and in particular to a driving device for an electric curtain and an electric curtain.

### BACKGROUND

The driving devices of the current electric curtains mostly are combinations of motors and multi-stage planetary gears, most of which are disposed along an axis inside a hollow cylinder. Therefore, high mounting accuracy is required and tedious mounting production has to be performed.

### SUMMARY

The present invention aims to address the first technical problem in the related arts at least to some degree: provided is a driving device for an electric curtain, which has low requirements for mounting accuracy and can realize easy production and mounting.

The present invention aims to address the second technical problem in the related arts at least to some degree: provided is an electric curtain, which has low requirements for mounting accuracy and can realize easy production and mounting.

For the above, one object of the present invention is to provide a driving device for an electric curtain in order to address the first technical problem. The driving device comprises a main box and a secondary box connected to an end of the main box. A motor and a planetary gear set in transmission connection with the motor are disposed inside the main box. A horizontal gear set is disposed inside the secondary box. The planetary gear set is in transmission connection with the horizontal gear set, and a transmission shaft in transmission connection with the horizontal gear set is disposed outside the secondary box.

Preferably, the main box is transversely disposed and the secondary box is vertically disposed.

Preferably, the transmission shaft and the main box are disposed at a same side of the secondary box.

Preferably, the horizontal gear set at least comprises a first gear and a second gear in transmission connection; the first gear is in transmission connection with the planetary gear set and the second gear is in transmission connection with the transmission shaft.

Preferably, the planetary gear set comprises a planetary carrier, a sun gear and an external ring gear. An end of the planetary carrier is connected to at least three planetary gears which are all meshed with the sun gear and the external ring gear. The sun gear is connected with the motor.

Preferably, a transmission gear is further comprised. An end of the transmission gear is in transmission connection with the horizontal gear set and the other end is connected to the planetary carrier in a circumferential limiting manner or fixedly.

Preferably, a connection housing is further comprised. An end of the connection housing is connected with the motor, and the other end is fitted to the secondary box. The external ring gear is disposed on an inner wall of the connection housing, and the connection housing is provided with a hole for the transmission gear to penetrate through.

Preferably, an end of the connection housing is provided with a fitting block and a support block abutted against the fitting block is disposed on the secondary box.

Preferably, an elastic block is disposed on the support block, and a recess matching the elastic block is disposed on the fitting block.

Preferably, the secondary box comprises a cover body, and a limiting block for achieving circumferential limitation with the fitting block is disposed on the cover body.

For the above, one object of the present invention is to provide an electric curtain in order to address the second technical problem. The electric curtain comprises a curtain assembly and any one of the above driving devices for the electric curtain at least disposed at an end of the curtain assembly. The transmission shaft is in transmission connection with the curtain assembly.

Preferably, an upper beam is comprised. An insertion groove for accommodating the main box is disposed respectively at both ends of the upper beam.

For the above, one object of the present invention is to provide an electric curtain in order to address the second technical problem. The electric curtain comprises a frame and a telescoping curtain disposed inside the frame as well as a curtain cross beam routing structure. In the curtain cross beam routing structure, a cross beam body is slidably connected within the external frame and connected to the telescoping curtain.

Additional aspects and advantages of the present invention will be partially given in the following descriptions and partially become obvious from the following descriptions or understood from the practice of the present invention.

The technical solutions have the following advantages and beneficial effects: the main boxy and the secondary box are separately assembled, only the motor and the single-stage planetary gear set are disposed inside the main box, and the single-stage planetary gear set can greatly reduce the mounting accuracy, facilitating production and mounting. The planetary gear set is rotatably connected to the horizontal gear set, and the horizontal gear set in the secondary box can perform speed reduction, so as to ensure the electric curtain runs stably, avoiding use of a multi-stage planetary gear structure. Furthermore, only the horizontal gear set is disposed inside the secondary box, such that the flat structure enables it to be easily disposed at one or two sides of the electric curtain. Thus, entire mounting is easier, the accuracy requirement is lower and operation is more stable and reliable.

### BRIEF DESCRIPTION OF THE DRAWINGS

In order to more clearly describe the technical solutions in the present invention, the accompanying drawings required for descriptions of some embodiments of the present invention will be briefly introduced. Obviously, the drawings described herein are only drawings of some embodiments of the present invention. Those skilled in the art can also obtain other drawings based on these drawings. Further, the drawings described below are considered as illustrative rather than limiting to the actual sizes of the products and the actual flows of the methods, the actual sequence of the signals and the like involved in the embodiments of the present invention.

FIG. 1 is a structural diagram illustrating an electric curtain according to some embodiments of the present invention.

FIG. 2 is a structural diagram illustrating a driving device for an electric curtain according to some embodiments of the present invention.

FIG. 3 is a top view illustrating a driving device for an electric curtain according to some embodiments of the present invention.

FIG. 4 is a schematic diagram illustrating a section taken along A-A in FIG. 3.

FIG. 5 is an enlarged view of the position B in FIG. 4.

FIG. 6 is a schematic diagram illustrating an internal structure of a driving device for an electric curtain according to some embodiments of the present invention.

FIG. 7 is an enlarged view of the position C in FIG. 6.

FIG. 8 is a structural schematic diagram illustrating a cover body of a driving device for an electric curtain according to some embodiments of the present invention.

FIG. 9 is a schematic diagram illustrating cooperation of a planetary gear set and a horizontal gear set in a driving device for an electric curtain according to some embodiments of the present invention.

FIG. 10 is an enlarged view of the position D in FIG. 9.

FIG. 11 is a structural diagram illustrating a connection housing of a driving device for an electric curtain according to some embodiments of the present invention.

Numerals of drawings are described below: 1. main box, 2. secondary box, 21. support block, 22. clastic block, 23. cover body, 24. limiting block, 3. motor, 4. planetary gear set, 41. planetary carrier, 42. planetary gear, 43. sun gear, 44. external ring gear, 5. horizontal gear set, 51. first gear, 52. second gear, 6. transmission shaft, 7. transmission gear, 8. connection housing, 81. hole, 82. fitting block, 83. recess, and 9. upper beam.

### DETAILED DESCRIPTIONS OF EMBODIMENTS

The technical solutions of some embodiments of the present invention will be fully and clearly described below in combination with drawings. Obviously, the embodiments described herein are only some embodiments of the present invention rather than all embodiments. All other embodiments obtained by those skilled in the art based on these drawings shall fall within the scope of protection of the present invention.

As used herein, “about” or “approximate” or “around” comprises the described value and an average value within an acceptable error range of the specific value, where the acceptable error range is determined by persons of ordinary skills in the arts considering a measurement being discussed and an error relating to the measurement of a specific amount (limitation of the measurement system).

An embodiment of the present invention provides an electric curtain, which may be, for example, one of rolling curtains.

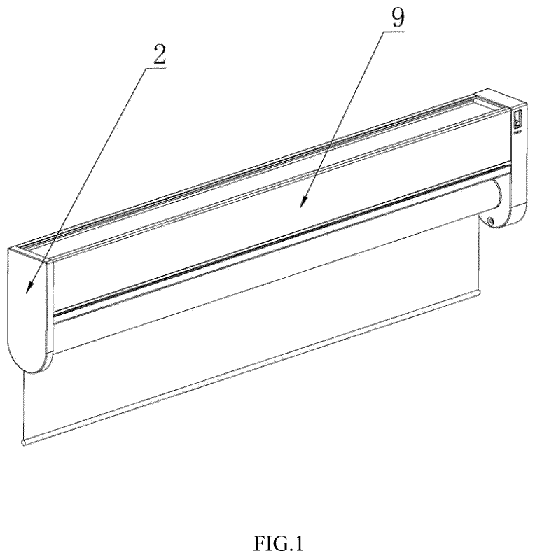

As shown in FIG. 1, an electric curtain comprises a curtain assembly and a driving device of the electric curtain at least disposed at an end of the curtain assembly. A transmission shaft 6 is in transmission connection with the curtain assembly, that is, the curtain assembly is driven to rotate by the transmission shaft 6 so as to roll up and down the curtain. Furthermore, a driving device for the electric curtain may be disposed at both ends of the electric curtain respectively or only at the end of the curtain assembly, so as to effectively drive the curtain assembly to rotate. The electric curtain may further comprise an upper beam 9, both ends of which are respectively provided with an insertion groove for accommodating a main box 1. With the upper beam 9, the entire product structure is made more stable and integral, and the main box 1 can be directly disposed inside the insertion grooves at both ends of the upper beam 9. In this way, easy assembling can be achieved and the entire volume is made smaller. Further, the structural integrity of the main box 1 is ensured. Correspondingly, only a horizontal gear set 5 is disposed inside a secondary box 2, such that a flat structure of the secondary box 2 enables the secondary box 2 to be easily disposed at one or both sides of the electric curtain, realizing a smaller entire volume. In addition, it is easy to mount and can stably fix the curtain assembly.

An embodiment of the present invention provides a driving device for an electric curtain. The driving device for the electric curtain is used to rotate the curtain or the like.

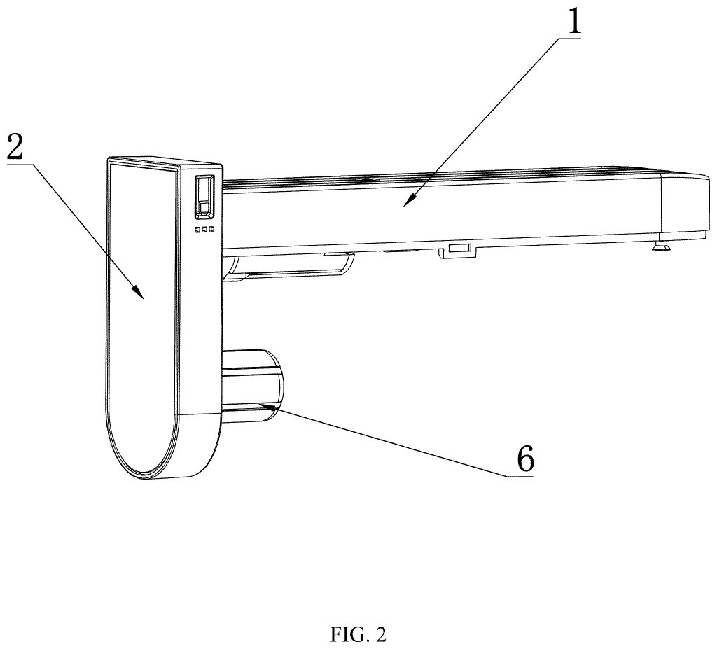

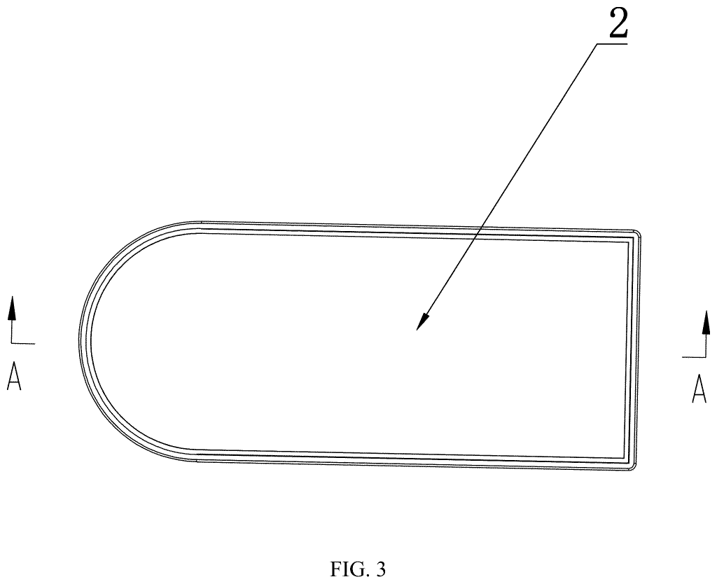

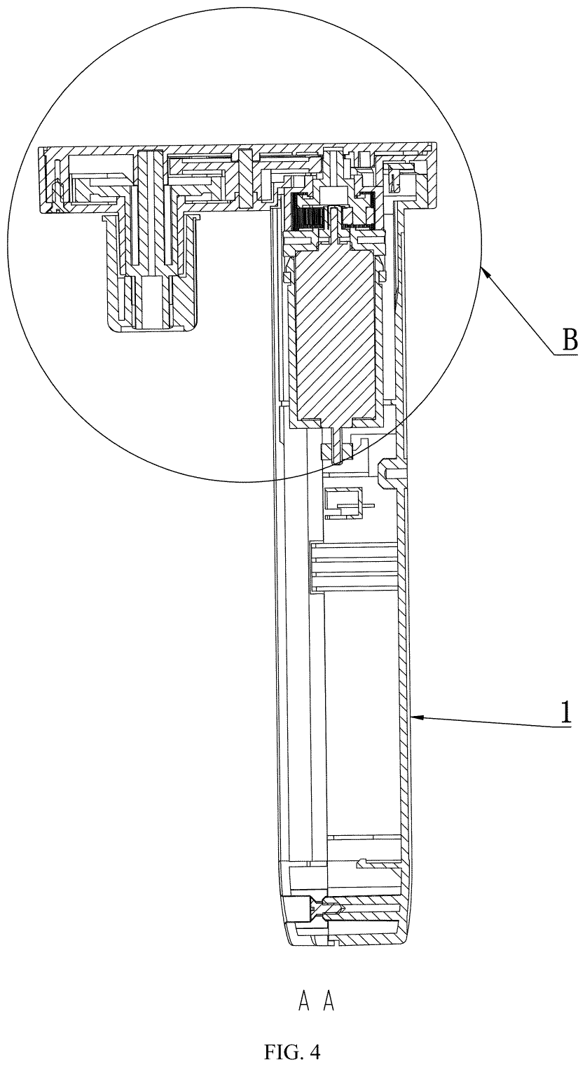

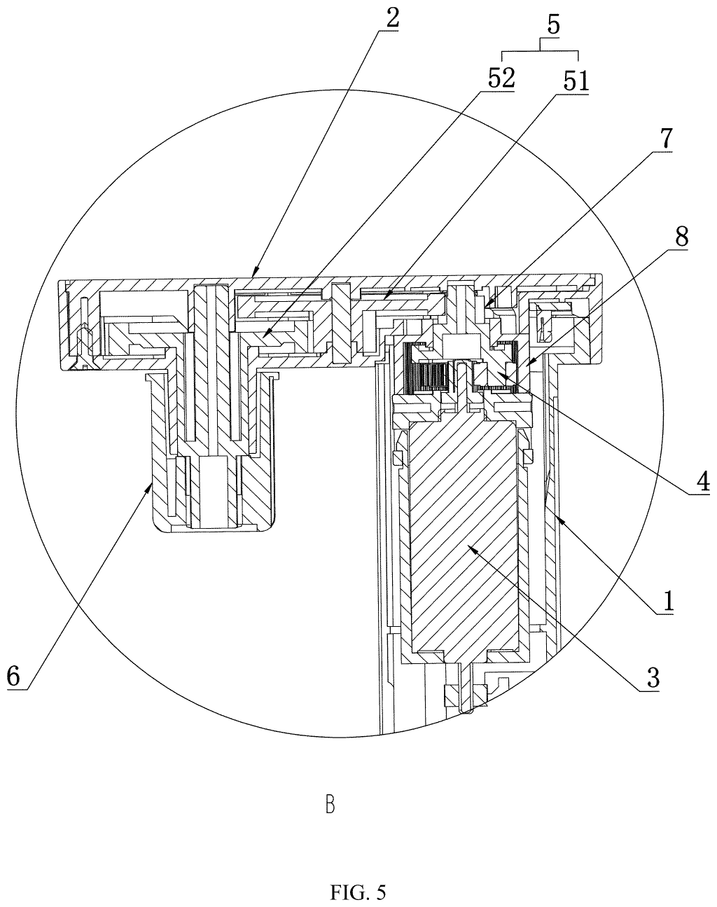

As shown in FIGS. 2 to 5, the driving device comprises a main box 1 and a secondary box 2 connected to an end of the main box 1. A motor 3 and a planetary gear set 4 in transmission connection with the motor 3 is disposed inside the main box 1 are disposed inside the main box 1. A horizontal gear set 5 is disposed inside the secondary box 2. The planetary gear set 4 is rotatably connected to the horizontal gear set 5. A transmission shaft 6 in rotatable connection with the horizontal gear set 5 is disposed outside the secondary box 2. The main box 1 is entirely long and can accommodate the motor 3 and a circuit board and the like. Moreover, a housing of the main box 1 is subjected to strength design, and hence, the main box 1 can serve as a structural member which can be fixed to an end of the upper beam 9 or a wall or the like to directly bear force and thus can stably hang the curtain or the like. Further, due to the flat structure, the secondary box 2 also can bear vertical force. The main box 1 accommodates the motor 3 and the planetary gear set 4 in transmission connection with the motor 3. The single-stage planetary gear set 4 is easy to mount and can run stably. The horizontal gear set 5 can further realize speed reduction. The horizontal gear set 5 has a smaller transverse size and can output power to the transmission shaft 6, which stably drives the curtain to rotate.

The main box 1 is disposed transversely and the secondary box 2 is vertically disposed such that both boxes can be disposed perpendicular to each other or approximately perpendicular to each other. Both boxes can stably bear force, which facilitates entire mounting and fixing of the electric curtain. The transmission shaft 6 and the main box 1 both are mounted at a same side of the secondary box 2 to clamp the curtain assembly and more stably drive the curtain assembly.

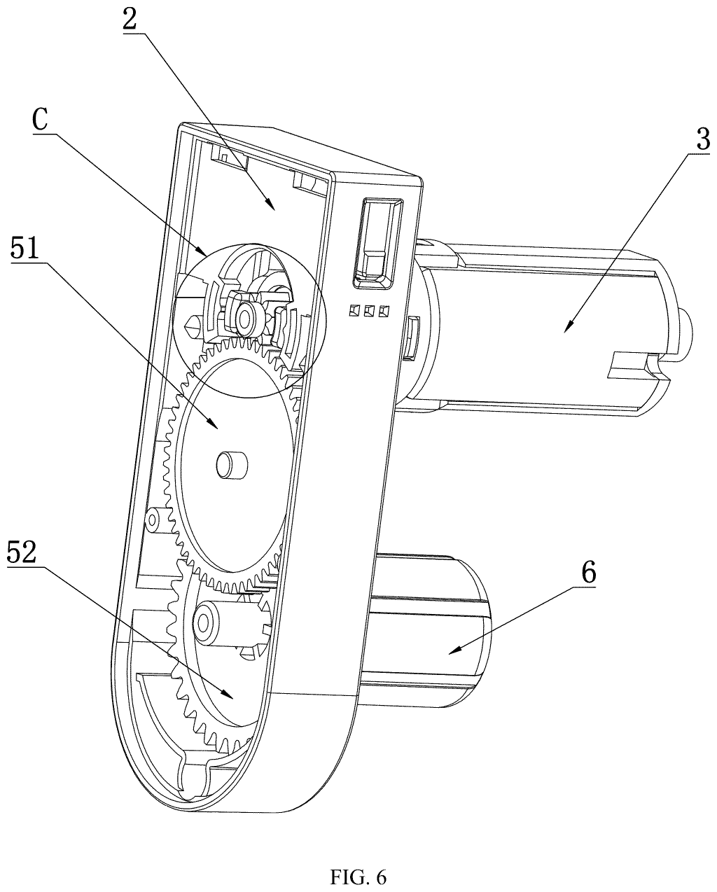

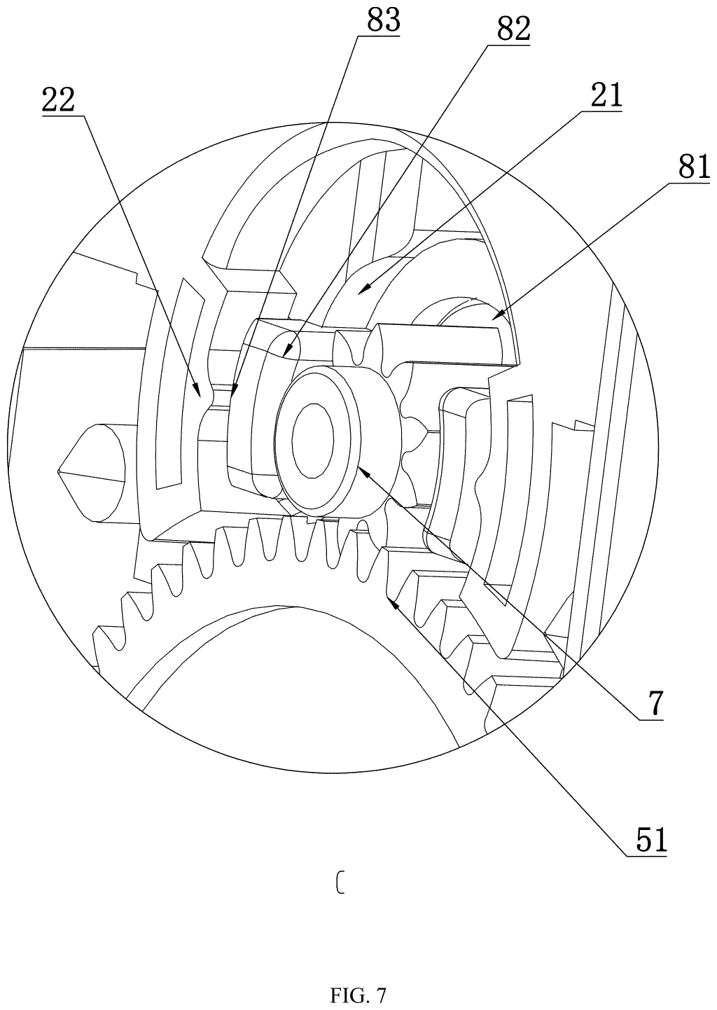

As shown in FIGS. 6 and 7, the horizontal gear set 5 at least comprises a first gear 51 and a second gear 52 in transmission connection. The first gear 51 is in transmission connection with the planetary gear set 4, and the second gear 52 is in transmission connection with the transmission shaft 6. The first gear 51 and the second gear 52 perform speed-reduced drive. Thus, the structure is stable and reliable. A transmission gear 7 is in transmission connection with the first gear 51 in the secondary box 2. The transmission gear 7 and the planetary gear set 4 are circumferentially limited, that is, the planetary gear set 4 and the horizontal gear set 5 are in transmission connection through the transmission gear 7, facilitating connection between the main box 1 and the secondary box 2.

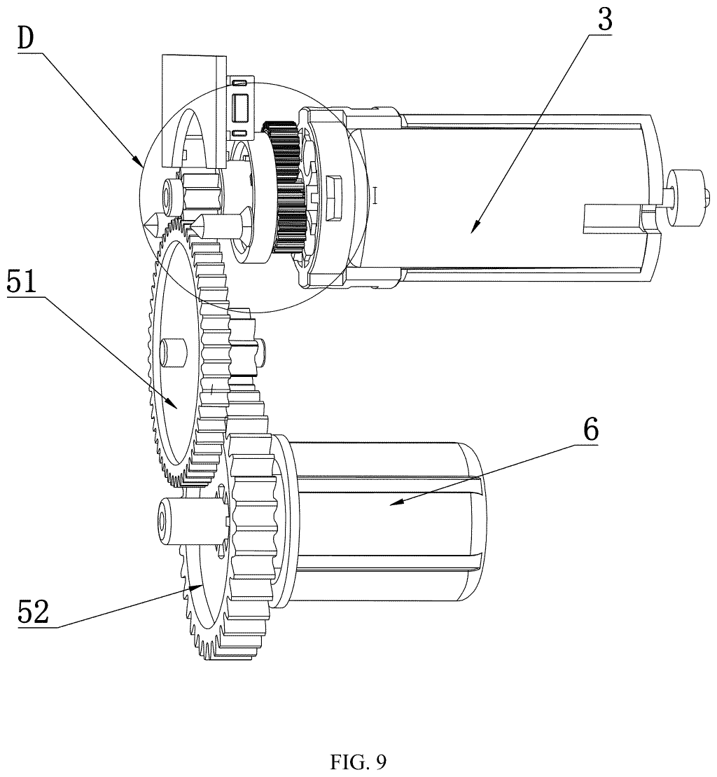

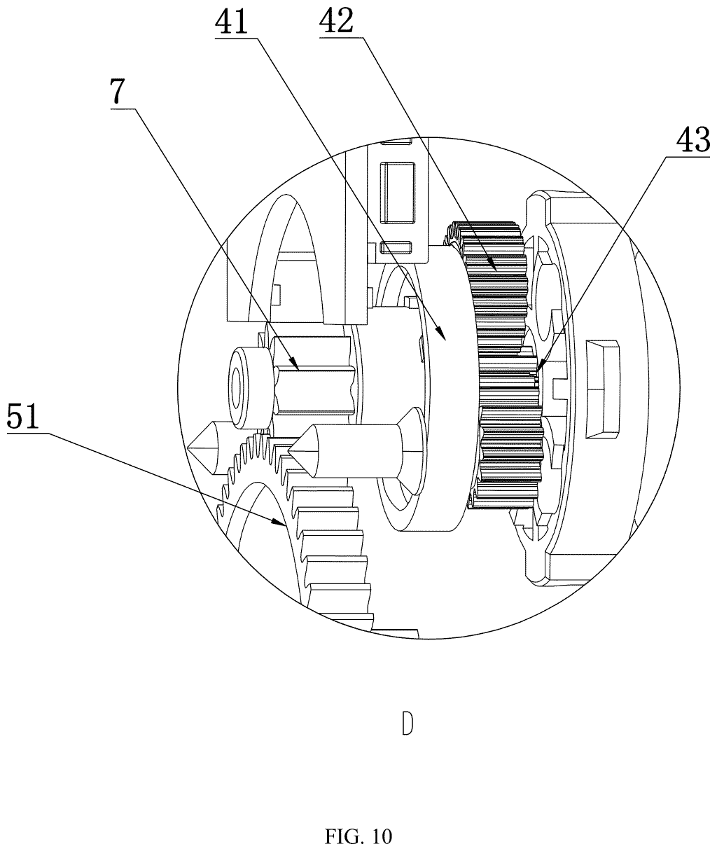

As shown in FIGS. 9 and 10, the planetary gear set 4 comprises a planetary carrier 41. The planetary carrier 41 and the transmission gear 7 are circumferentially limited or fixedly connected so as to achieve connection between the planetary gear set 4 and the transmission gear 7. When the main box 1 and the secondary box 2 are inserted mutually, the transmission gear 7 is connected to the horizontal gear set 5. The planetary gear set 4 comprises the planetary carrier 41, a sun gear 43 and an external ring gear 44. An end of the planetary carrier 41 is connected to the transmission gear 7 in a circumferential limiting manner and the other end is rotatably connected to at least three planetary gears 42. The planetary gears 42 are all meshed with the sun gear 43 and the external ring gear 44. The sun gear 43 and the motor 3 are fixedly connected or circumferentially limited, facilitating mounting and stable and reliable running at reduced speed.

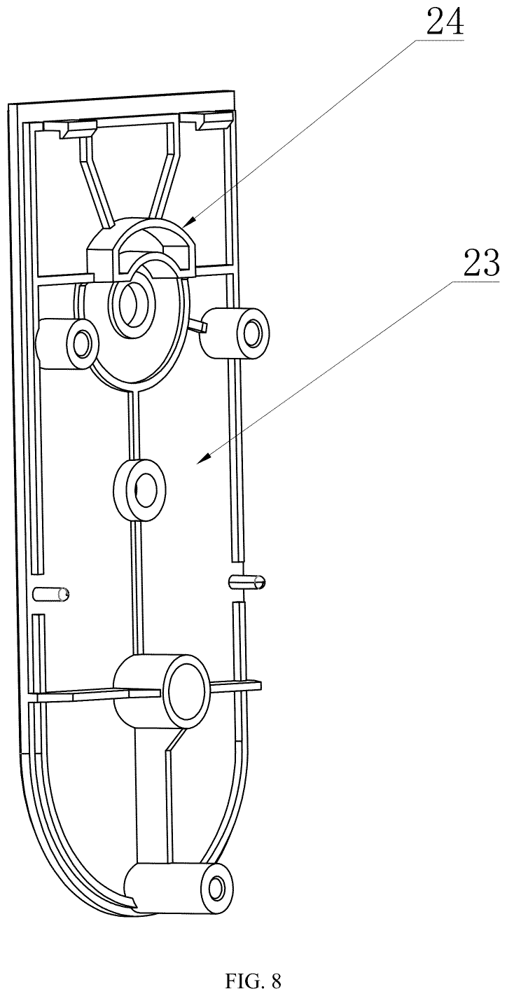

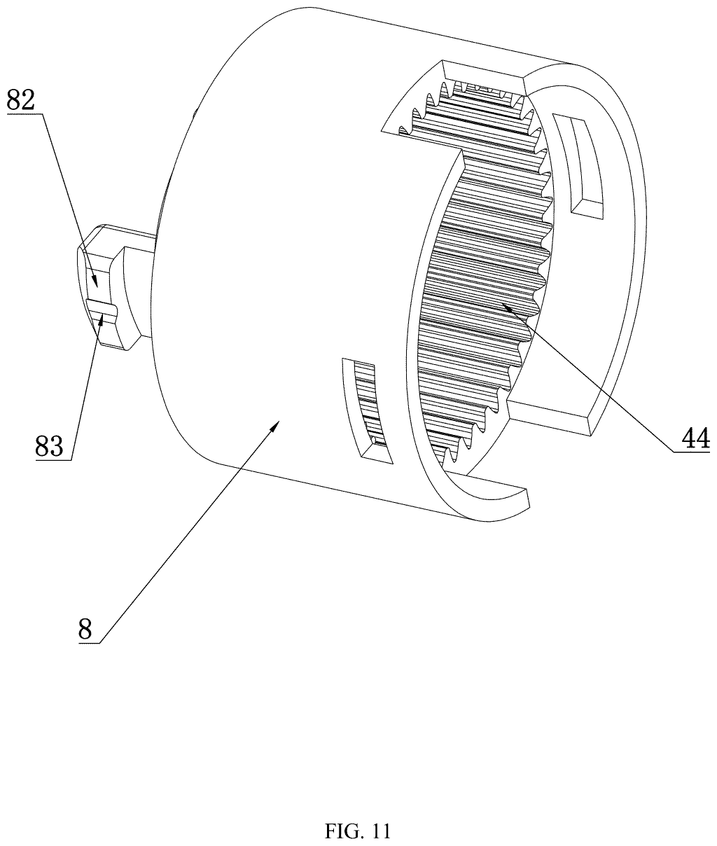

As shown in FIGS. 7, 8 and 11, a connection housing 8 is comprised. An end of the connection housing 8 is connected to the motor 3, and the other end is fitted to the secondary box 2. The external ring gear 44 is disposed on an inner wall of the connection housing 8. Further, the connection housing 8 is provided with a hole 81 for the transmission gear 7 to penetrate through, that is, the planetary gear set 4 is entirely disposed inside the connection housing 8. The planetary gear set 4 may be mounted in the connection housing 8 and the motor 3 to form an integral structure which is then inserted onto the secondary box 2, helping easier mounting. An end of the connection housing 8 is provided with a fitting block 82 and a support block 21 abutted against the fitting block 82 is disposed on the secondary box 2. Thus, the connection housing 8 can be fitted to the secondary box 2 through the fitting block 82 to achieve transverse limiting. An elastic block 22 is disposed on the support block 21, and a recess 83 matching the elastic block 22 is disposed on the fitting block 82. By matching between the elastic block 21 and the recess 83, circumferential limiting is achieved, such that the fitting block 82 and the support block 21 can be stably mated. The secondary box 2 comprises a cover body 23, and a limiting block 24 for achieving circumferential limitation with the fitting block 82 is disposed on the cover body 23 to limit movement of the fitting block 82 abutted against the support block 21, especially limit circumferential movement of the fitting block 82. In this way, the fitting block 82 can be always abutted against the support block 21. After the connection housing 8 is rotatably fitted to the secondary box 2, the cover body 23 can be fixed, thereby achieving easy mounting and stable structure.

The above descriptions are made only to the specific embodiments of the present invention and the scope of protection of the present invention is not limited to these embodiments. Any changes or substitutions conceived of by those skilled in the arts within the technical scope of the present invention shall all fall within the scope of protection of the present invention. Therefore, the scope of protection of the present invention shall be indicated by the scope claimed by the claims.

1. A driving device for an electric curtain, wherein the driving device comprises a main box (1) and a secondary box (2) connected to an end of the main box (1); a motor (3) and a planetary gear set (4) in transmission connection with the motor (3) are disposed inside the main box (1); a horizontal gear set (5) is disposed inside the secondary box (2); the planetary gear set (4) is in transmission connection with the horizontal gear set (5), and a transmission shaft (6) in transmission connection with the horizontal gear set (5) is disposed outside the secondary box (2).

2. The driving device for an electric curtain of claim 1, wherein the main box (1) is transversely disposed and the secondary box (2) is vertically disposed.

3. The driving device for an electric curtain of claim 1, wherein the transmission shaft (6) and the main box (1) are disposed at the same side of the secondary box (2).

4. The driving device for an electric curtain of claim 1, wherein the horizontal gear set (5) comprises at least a first gear (51) and a second gear (52) in transmission connection; the first gear (51) is in transmission connection with the planetary gear set (4) and the second gear (52) is in transmission connection with the transmission shaft (6).

5. The driving device for an electric curtain of claim 1, wherein the planetary gear set (4) comprises a planetary carrier (41), a sun gear (43) and an external ring gear (44); an end of the planetary carrier (41) is connected to at least three planetary gears (42) which are all meshed with the sun gear (43) and the external ring gear (44); the sun gear (43) is connected with the motor (3).

6. The driving device for an electric curtain of claim 5, wherein it further comprises a transmission gear (7); an end of the transmission gear (7) is in transmission connection with the horizontal gear set (5) and the other end is connected to the planetary carrier (41) in a circumferential limiting connection or fixed connection.

7. The driving device for an electric curtain of claim 6, wherein it further comprises a connection housing (8); an end of the connection housing (8) is connected with the motor (3), and the other end is fitted to the secondary box (2); the external ring gear (44) is disposed on an inner wall of the connection housing (8), and the connection housing (8) is provided with a hole (81) for the transmission gear (7) to penetrate through.

8. The driving device for an electric curtain of claim 7, wherein an end of the connection housing (8) is provided with a fitting block (82) and a support block (21) abutted against the fitting block (82) is disposed on the secondary box (2).

9. The driving device for an electric curtain of claim 8, wherein an elastic block (22) is disposed on the support block (21), and a recess (83) matching the elastic block (22) is disposed on the fitting block (82).

10. The driving device for an electric curtain of claim 9, wherein the secondary box (2) comprises a cover body (23), and a limiting block (24) for circumferential limitation with the fitting block (82) is disposed on the cover body (23).

11. An electric curtain, wherein the curtain comprises a curtain assembly and the driving device of claim 1, which disposed at least at an end of the curtain assembly; the transmission shaft (6) is in transmission connection with the curtain assembly.

12. The electric curtain of claim 11, wherein it further comprises an upper beam (9); an insertion groove for accommodating the main box (1) is disposed respectively at both ends of the upper beam (9).

13. The driving device for an electric curtain of claim 2, wherein the transmission shaft (6) and the main box (1) are disposed at the same side of the secondary box (2).
